(19) United States
(12) Patent Application Publication
(10) Pub. No.: US 2015/0121474 A1
(43) Pub. Date: Apr. 30, 2015

(54) PROCESSOR SECURITY AUTHENTICATION AREA

(71) Applicant: Samsung Electronics Co., Ltd., Gyeonggi-do (KR)

(72) Inventors: Tymur KORKISHKO, Gyeonggi-do (KR); Kyung-Hee LEE, Gyeonggi-do (KR); Anton GROPYANOV, Kherson (UA); Sergii KOVBA, Mariupol (UA); Sergiy BELOUSOV, Cherkassy (UA)

(21) Appl. No.: 14/529,831

(22) Filed: Oct. 31, 2014

(30) Foreign Application Priority Data
Oct. 31, 2013 (KR) 10-2013-0131710

(51) Int. Cl. H04L 29/06

(52) U.S. Cl. CPC H04L 63/0823; H04L 63/10; H04L 63/083; H04L 63/0861
USPC 726/4

(57) ABSTRACT

Disclosed herein are a method and electronic device for enhancing the security of sensitive operations. Control is switched from a first driving area to a second driving area of at least one processor. Security authentication is performed by the second driving area and a result of the authentication is output.

### CLAIM OF PRIORITY

This application claims priority under 35 U.S.C. §119 to an application filed in the Korean Intellectual Property Office on Oct. 31, 2013 and assigned Serial No. 10-2013-0131710, the entire contents of which are incorporated herein by reference.

### BACKGROUND

1. Technical Field Disclosure

The present disclosure relates to a method and apparatus for providing a security status of an electronic device.

2. Description of the Related Art

With the development of information and communication technology and semiconductor technology, electronic devices provide a variety of services such as a voice communication service, a messenger service, a broadcasting service, and a wireless Internet service, and serve as an important means for delivering information. As such, electronic devices are considered a necessity in modern society. Recently, electronic devices have developed the capability of providing secure financial transactions and business processing services. Accordingly, electronic devices may store security information associated with financial transactions and business processes.

While carrying out a secure transaction, an electronic device may display a security status of the electronic device via various display modules included therein that allows a user to be aware of their device's security status. In addition, a user may change a status of their device without discretion. However, a user may inadvertently compromise the security of their device, while changing a status of the device.

### SUMMARY

In view of the above, provided herein are an apparatus and method for preventing a user from inadvertently compromising the security of their device. The techniques disclosed herein prevent a status output operation from outputting a security status different from the security level of the device when checking a security status of an electronic device.

Another aspect of the present disclosure is to provide an apparatus and method for displaying a status in which security-sensitive operation and data are processed by using a security area of a processor which are physically or logically separated from a general area of the processor for processing a user interface service.

Another aspect of the present disclosure is to provide an apparatus and method for determining whether an application program functions or not based on a security status of a general area checked in a security area of an electronic device.

In accordance with an aspect of the present disclosure, a method for operation of an electronic device includes: displaying a security authentication screen in a first driving area; switching from a first driving area execution mode to a second driving area execution mode; performing a security authentication procedure in the second driving area; and outputting a first display corresponding to the security authentication screen or a second display corresponding a result of the security authentication procedure under the control of the second driving area.

In accordance with another aspect of the present disclosure, an electronic device includes: a memory for storing security information of the electronic device; a display device for outputting one or more displays in accordance with the security information; a processor for displaying a security authentication screen in a first driving area, switching from a first driving area execution mode to a second driving area execution mode, performing a security authentication procedure in the second driving area; and outputting a first display corresponding to the security authentication screen or a second display corresponding a result of the security authentication procedure to the at least one display device under the control of the second driving area.

### BRIEF DESCRIPTION OF THE DRAWINGS

The above features and advantages of the present disclosure will become more apparent from the following detailed description when taken in conjunction with the accompanying drawings in which:

FIG. 1 is a block diagram 100 of an example electronic device 101 in accordance with aspects of the present disclosure;

FIG. 2A, FIG. 2B and FIG. 2C are working examples of a processor in accordance with aspects of the present disclosure;

FIG. 3A, FIG. 3B and FIG. 3C are working examples of a processor in accordance with aspects of the present disclosure;

FIG. 4A, FIG. 4B and FIG. 4C are working examples of a processor in accordance with aspects of the present disclosure;

FIG. 5 is a flowchart illustrating an example method in accordance with aspects of the present disclosure;

FIG. 6 is a flowchart illustrating a further example method in accordance with aspects of the present disclosure;

FIG. 7 is a flowchart illustrating yet another example method in accordance with aspects of the present disclosure; and

FIG. 8 is a block diagram of example hardware 800 in accordance with aspects of the present disclosure.

### DETAILED DESCRIPTION

Examples of the present disclosure will be described herein with reference to the accompanying drawings. Although specific examples of the present disclosure are illustrated in the drawings and relevant detailed descriptions are provided, various changes may be made to the examples. Accordingly, the various examples of the present disclosure are not limited to those described herein and should be construed as including all changes and/or equivalents or substitutes included within the technological scope of the present disclosure. In the drawings, similar reference numerals are used for similar elements. In addition, detailed descriptions of well-known functions or configurations will be omitted since they would unnecessarily obscure the subject matter of the present disclosure. Accordingly, only the subject matter necessary to understand the techniques of the present disclosure will be provided.

The term “include” or “may include” used in the examples of the present disclosure indicates the presence of corresponding functions, operations, elements, etc., and does not preclude additional functions, operations, elements, etc. In addition, it should be understood that the term “include” or “has” indicates the presence of features, numbers, steps, operations, elements, parts, or a combination thereof described in the specifications, and does not preclude the presence or addition of one or more other features, numbers, steps, operations, elements, parts, or a combination thereof.

An electronic device for carrying out the techniques herein may be equipped with a communication function. For example, the electronic device may include a smartphone, a tablet PC, a mobile phone, a video phone, an electronic book reader, a desktop PC, a laptop PC, a net book computer, a Personal Digital Assistant (PDA), a Portable Multimedia Player (PMP), an MP3 player, a mobile medical machine, a camera, and a wearable device (e.g., at least one of a Head-Mounted-Device (HMD) such as electronic glasses, electronic clothing, an electronic bracelet, an electronic necklace, an electronic accessory, or a smart watch).

In one example, the electronic device may be a smart home appliance which is equipped with a communication function. For example, the smart home appliance may include at least one of a television, a Digital Versatile Disk (DVD) player, a stereo, a refrigerator, an air conditioner, a cleaner, an oven, a microwave oven, a washing machine, an air cleaner, a set-top box, a TV box (for example, Samsung HomeSync™, Apple TV™, or Goggle TV™), a game console, an electronic dictionary, an electronic key, a camcorder, or an electronic album.

In a further example, the electronic device may include at least one of various medical machines (e.g., Magnetic Resonance Angiography (MRA), Magnetic Resonance Imaging (MRI), Computerized Tomography (CT), a tomograph, an ultrasound machine, etc.), a navigation device, a Global Positioning System (GPS) receiver, an Event Data Recorder (EDR), a Flight Data Recorder (FDR), an automotive infotainment device, an electronic equipment for ship (for example, a navigation equipment for ship, a gyro compass, etc.), an airline electronic device, or a security device.

The electronic device may include at least one of a part of furniture or a building/a structure equipped with a communication function, an electronic board, an electronic signature input device, a projector, and various measurement devices (for example, water, power, gas, radio waves, etc.). The electronic device in accordance with the present disclosure may be one or a combination of one or more of the above-mentioned devices. In addition, it is obvious to an ordinary skilled person in the related art that the electronic device in accordance with the present disclosure is not limited to the above-mentioned devices. Hereinafter, an example electronic device will be described with reference to the accompanying drawings. The term “user” may refer to a person who uses the electronic device or a device that uses the electronic device (e.g., an artificial intelligence electronic device).

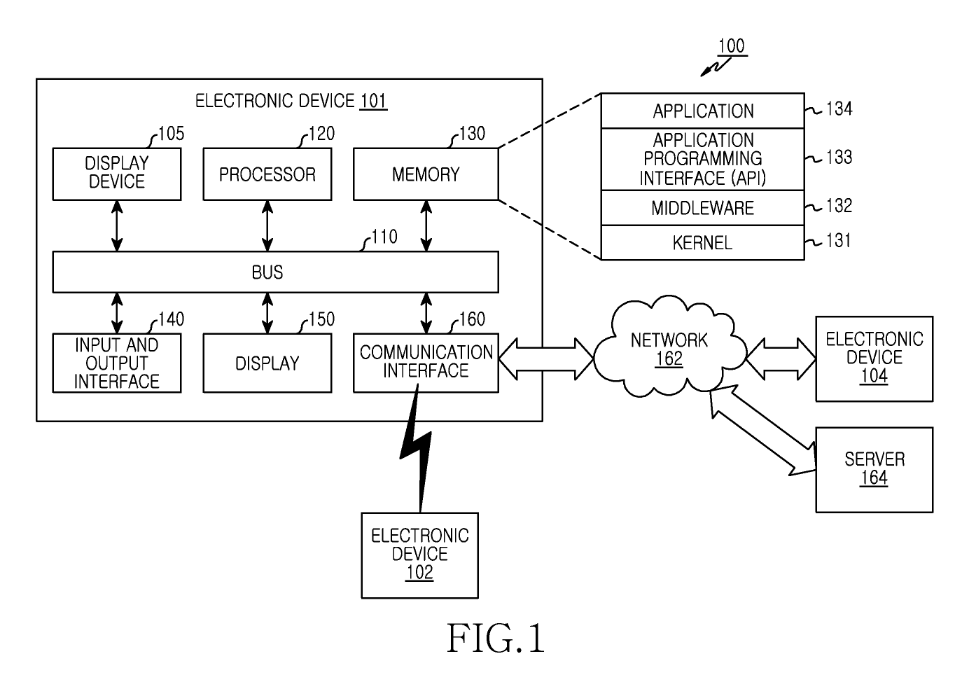

Referring to the example electronic device of FIG. 1, the electronic device 101 may include a display device 105, a bus 110, a processor 120, a memory 130, an input and output interface 140, a display device 105, or a communication interface 160.

The display device 105 may output a display signal indicative of a security level of the electronic device 101 under the control of a first driving area or a second driving area of the processor 120 of the electronic device 101. The display device 105, which outputs the display signal of the electronic device 101, may be at least one of one or more light emitting elements such as Light Emitting Diode (LED) included in the electronic device 101, a level meter, and some or all areas of the display device 105.

The bus 110 may be a circuit which connects the above-described elements to each other and delivers communication (e.g., a control message) between the above-described elements.

The processor 120 may receive an instruction from the other elements described above (e.g., the memory 130, the input and output interface 140, the display device 105, the communication interface 160, etc.) via the bus 110, decipher the received instruction, and perform an operation or data processing in accordance with the deciphered instruction.

The memory 130 may store an instruction or data which is received from or generated by the processor 120 or the other elements (e.g., the input and output interface 140, the display device 105, the communication interface 160, etc.). The memory 130 may include programming modules such as a kernel 131, middleware 132, an Application Programming Interface (API) 133, or an application 134. Each of the programming modules may be configured by software, firmware, hardware, or a combination of two or more of them.

The kernel 131 may control or manage system resources (e.g., the bus 110, the processor 120 or the memory 130, etc.) which are used for performing operations or functions implemented by the other programming modules, for example, the middleware 132, the API 133, or the application 134. In addition, the kernel 131 may provide an interface for allowing the middleware 132, the API 133, or the application 134 to access an individual element of the electronic device 101 and control or manage the element.

The middleware 132 may serve as an intermediary to allow the API 133 or the application 134 to communicate with the kernel 131 and exchange data with the kernel 131. In addition, the middleware 132 may perform load balancing with respect to work requests received from the application 134 (a plurality of applications), for example, by giving priority to use the system resources of the electronic device 101 (for example, the bus 110, the processor 120, the memory 130, etc.) to at least one of the applications 134 (the plurality of applications).

The API 133 is an interface for allowing the application 134 to control a function provided by the kernel 131 or the middleware 132, and, for example, may include at least one interface or function for controlling a file, controlling a window, processing an image, or controlling a text.

The input and output interface 140 may receive an instruction or data from the user and may transmit the same to the processor 120 or the memory 130 via the bus 110, for example. The display device 105 may display an image, a video, or data for the user. In one example, when the display device 105 is provided as a touch screen, an instruction may be input through a gesture of touching or hovering (e.g., an indirect touch input) over the display device 105.

The communication interface 160 may establish communication between the electronic device 101 and an auxiliary electronic device 102, an electronic device 104, or a server 164. The communication interface 160 may support a predetermined short-range communication protocol over network 162 (e.g., Wireless Fidelity (Wi-Fi), Bluetooth (BT), Near Field Communication (NFC), or predetermined network communication (e.g., Internet, a Local Area Network (LAN), a Wide Area Network (WAN), a telecommunication network, a cellular network, a satellite network, a Plain Old Telephone Service (POTS), etc.)). Each of the electronic devices 102 and 104 may be the same device as the electronic device 101 (e.g., the same type of device) or a different device (e.g., a different type of device).

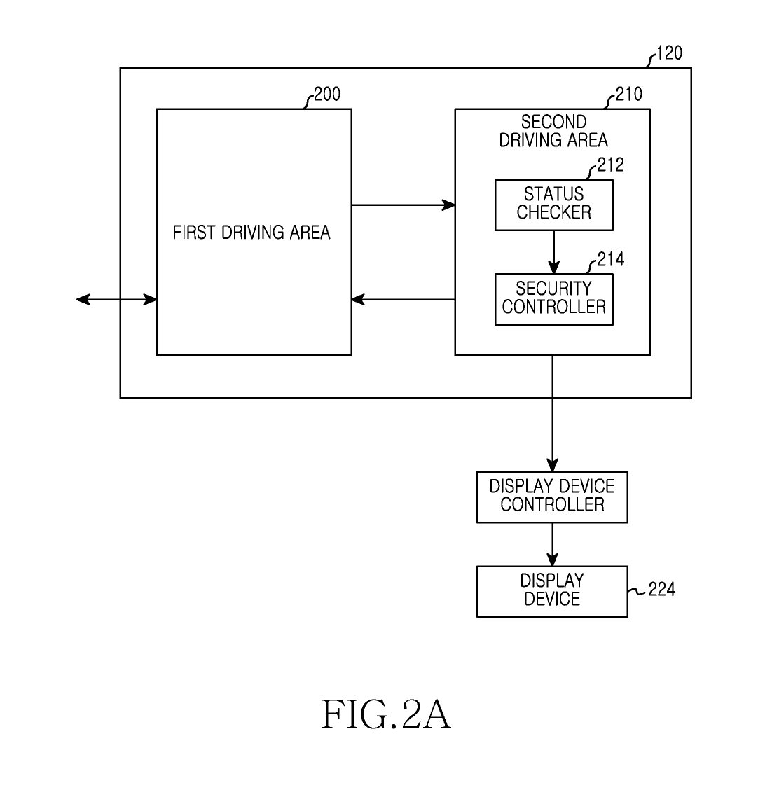

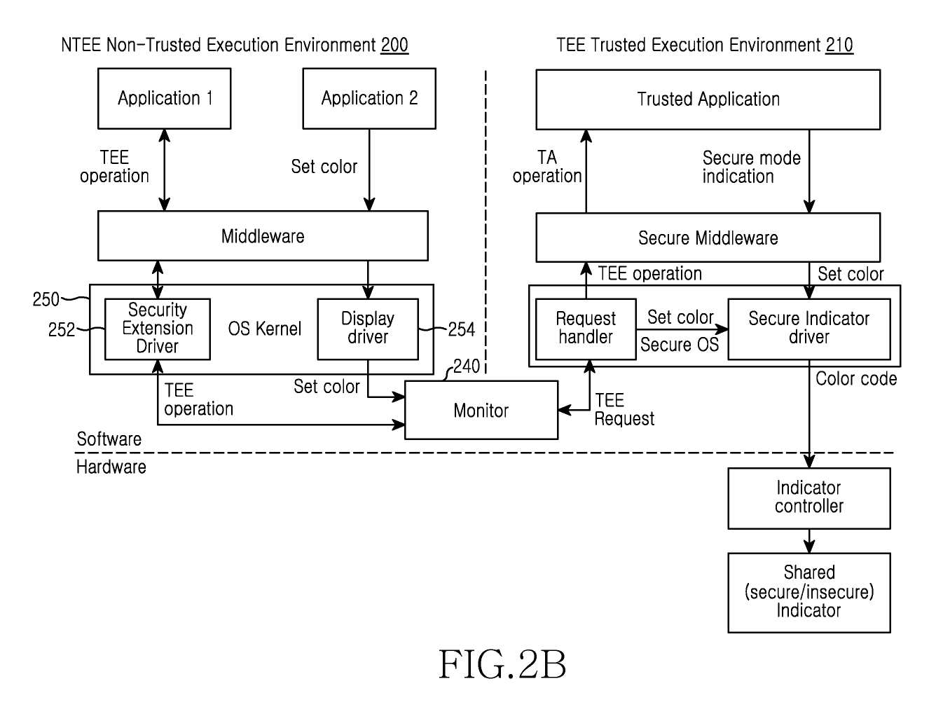

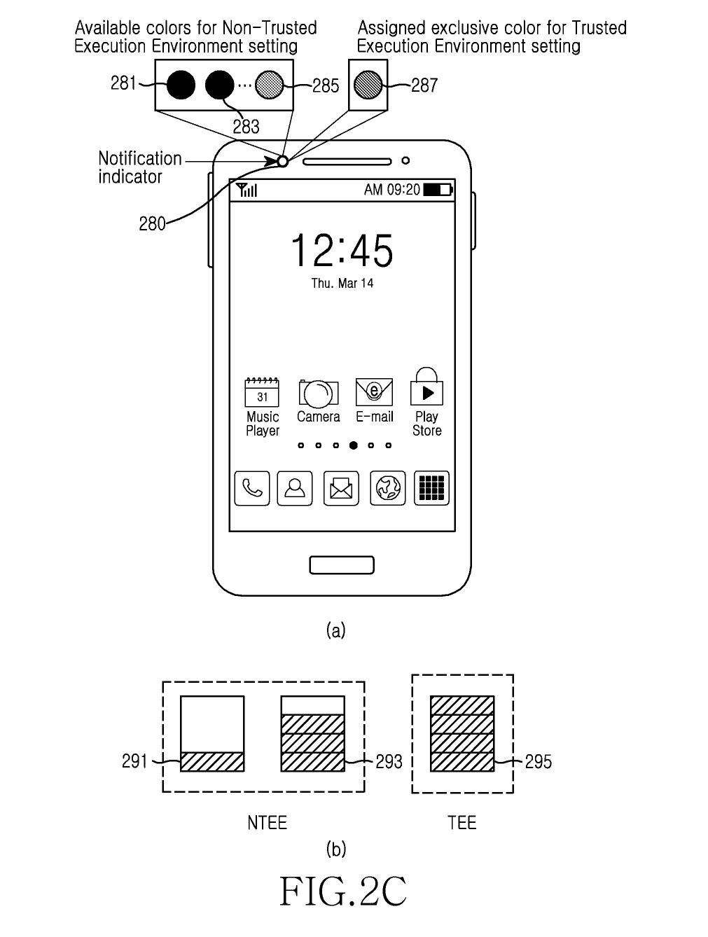

Referring to the working examples of FIGS. 2A and 2B, the processor 120 may include a first driving area 200 and a second driving area 210. The first driving area 200 controls a user interface service by executing a first operating system stored in the memory 130. In this case, the first driving area 200 may be referred to as a general area. For example, when an application program requiring security management is installed, the first driving area 200 may request an external server 164 to install the application program via the communication interface 160. When a security status information request signal of the electronic device 101 is received from the external server 164, the first driving area 200 may request the second driving area 210 to transmit security status information of the electronic device 101 or to perform a security authentication procedure. When the first driving area 200 receives the security status information of the electronic device 101 from the second driving area 210, the first driving area 200 may transmit the security status information or a result of the security authentication procedure of the electronic device 101 to the external server via the communication interface 160. When the first driving area 200 receives installation approval information of the application program from the external server, the first driving area 200 may install the application requiring the security management by using a first operating system.

In another example, the first driving area 200 may request the second driving area 210 to store an identification code (e.g., a secret key) of an application program requiring a security environment. When the application program requiring the security environment requires the identification code, the first driving area 200 may allow the application program to request the second driving area 210 to identify the identification code.

The second driving area 210 may process an operation and data related to security by executing a second operating system stored in the memory 130. In this case, the second driving area 210 may be referred to as a security area. For example, the second driving area 210 may include a status checker 212 and a security controller 214.

The status checker 212 may identify a parameter for determining a security status of the electronic device 101. For example, when the electronic device 101 is booted, the status checker 212 may identify one or more of a system binary generated by booting the electronic device 101, and information on whether authority to access a service via a kernel is set or not. When the system binary is identified, the second driving area 210 may generate a hash value on the system binary of the electronic device 101 and may store the hash value in the memory 130. In another example, the status checker 212 may periodically identify a kernel binary.

The security controller 214 may control an operation of the first driving area 200 or second driving area 210 in accordance with a security status of the electronic device 101. For example, when a status information request signal of the electronic device 101 is received by the first driving area 200, the security controller 214 may encrypt security status information of the electronic device 101 and may transmit it to the first driving area 200. The security status information of the electronic device 101 may include one or more system binaries identified in the processor 120 at the time of booting, a security status parameter of the electronic device 101, and status information of the kernel binary periodically identified. In this instance, the security status parameter of the electronic device 101 may indicate the security status of the electronic device 101 in accordance with one or more of the system binaries generated by booting the electronic device 101 and information on whether the authority to access the service via the kernel is set or not.

In another example, when an application program requiring security management requests identification and/or storage of an identification code in the first driving area 200, the security controller 214 may receive the identification code of the application program, and may store the received identification code in the memory 130. When the first driving area 200 requests the identification code of the application program, the security controller 214 may selectively transmit the identification code of the application program in accordance with the security status of the electronic device 101. For example, when a change history of the system binary of the electronic device 101 is not identified, the security controller 214 may provide the identification code of the application program to the first driving area 200. On the other hand, when the change history of the system binary of the electronic device 101 is identified, the security controller 214 may restrict the transmission of the identification code of the application program. In this case, the processor 120 may identify the change history of the system binary of the electronic device 101 based on one or more of status information of the system binary identified at the time of booting of the electronic device 101 and status information of the kernel binary periodically identified.

In the above example, the processor 120 may be logically divided into the first driving area 200 which executes the first operating system and the second driving area 210 which executes the second operating system. In one example, the first driving area (e.g., a logically separated use environment) 200 and the second driving area 210 may be logically separated in the processor, so that, when the security information needs to be identified while the first operating system is being operated by the first driving area, an OS operating environment of the electronic device 101 may switch to the second operating system by the second driving area 210. The first operating system and the second operating system operated in the electronic device 101 may be operated by their respective driving areas (e.g., the first driving area 200 and the second driving area 210, or may be operated by a single driving area.

In a further example, the processor 120 may be physically divided into the first driving area 200 which executes the first operating system and the second driving area 210 which executes the second operating system. In a further example, when one or more processors 120 included in the electronic device 101 is configured by multi core such as dual core or quad core, one or more cores are designated and set to operate as the first driving area or the second driving area 210. Each of two or more multi cores included in the processor 120 may be controlled to operate a corresponding operating systems, while switching to the first driving area or the second driving area in accordance with a status of the electronic device 101.

Referring back to FIG. 1, the electronic device 101 may notify a security status of the electronic device 101 through various devices included in the electronic device 101, for example, by outputting a security level identifying the security status (e.g., a level of security) to a light emitting element (e.g., a color of light emitted from the light emitting element in the electronic device in accordance with each security level), displaying the security level on a designated area of the display device 105, or outputting the security level in a vibration pattern. The electronic device 101 may restrict the display of the security level to display under the control of the second driving area 210. In one example, the processor 120 of the electronic device 101 may include the first driving area 200 which operates as a general execution environment (Non Trusted Execution Environment (NTEE)) and the second driving area 210 which operates as a security execution environment (Trusted Execution Environment (TEE)). The first driving area 200 and the second driving area 210 may be physically separated from each other by each core of the processor 120, or may be separated in a single core by switching a use environment. The electronic device 101 may be configured to receive the control of the second driving area 210 to output the security status of the electronic device 101.

Hereinafter, an example of the present disclosure will be described with reference to FIG. 2A. Referring to FIG. 2A, the display device of the electronic device 101 may be configured to display the security status of the electronic device 101 by means of the first driving area 200 and the second driving area 210. In displaying the security status of the electronic device 101 on a display device 224, the electronic device 101 may display the security status of the electronic device 101 which is determined in the first driving area 200 via the second driving area 210.

In one example, the electronic device 101 may perform a mobile banking function while being operated in the first driving area 200 (via the first driving area 200). The electronic device 101 may call the second driving area 210 to perform a security environment authentication procedure of a smart wallet function. The first driving area 200 may transmit security level information indicating that the electronic device 101 is performing the security environment authentication procedure or that the electronic device 101 working with a designated security environment in the second driving area 210. The second driving area 210 may determine whether or not the security level information received from the first driving area 200 has been modified, and, when the security level information is not modified, may display security level information on the display device 105 of the electronic device 101. When the display device 105 of the electronic device 101 is an LED which is able to output one or more designated colors, the security level information transmitted from the first driving area 200 to the second driving area 210 may be displayed as a designated color corresponding to the security status of the electronic device 101.

In another example, when the display device 105 of the electronic device 101 is a level meter which is able to display one or more stages, the security level information transmitted from the first driving area 200 to the second driving area 210 may be displayed as stage information corresponding to the security status of the electronic device 101. The second driving area 210 may process a function performed in the electronic device 101 using the designated security environment defined by the second operating system of the electronic device 101. In a further example, while the second driving area 210 is being operated, the first driving area 200 may maintain a holding status and the first operating system operated by the first driving area 200 may maintain a holding status or may be operated by the second driving area 210 (may be temporarily operated). The electronic device 101 may perform an authentication procedure for performing a mobile banking function via the second driving area 210. The electronic device 101 may request an input of an identification code via an input device of the electronic device 101 in order to the identification code to the authentication procedure of the mobile banking function. When the security status of the electronic device 101 is changed while receiving the input of the identification code, the second driving area 210 may display security level information corresponding to the changed security status on the display device 105. In a normal situation, the input device of the electronic device 101 may receive input using the first operating system controlled by the first driving area 200, and in a situation in which it is necessary to maintain a designated security such as in the case of the mobile banking function, the second driving area 210 may access the input device of the electronic device 101. The second driving area 210 may sense an unallowable change of data based on the second operating system while the identification code of the user is being input to the input device of the electronic device 101. When the second driving area 210 senses the unallowable change of data, the second driving area 210 may display the data change via the display device 105, and precludes processing the input of the identification code and terminates the authentication procedure. A code associated with a delay of the authentication procedure may be displayed. In addition, the second driving area 210 may terminate the authentication procedure with an error code. When the authentication procedure of the mobile banking is terminated, the first driving area 200 or the second driving area 210 may display or output the current security level of the device.

Hereinafter, an example of the present disclosure will be described with reference to FIG. 2B. Referring to FIG. 2B, the processor 120 of the electronic device 101 may be configured to go through a monitor module 240 when sharing all or some of the data between the first driving area 200 and the second driving area 210. The monitor module 240 may store data which is exchanged between the first driving area 200 and the second driving area 210. In one example, when the electronic device 101 requires the identification code input requiring security while being operated in the first driving area 200, the electronic device 101 may switch to the second driving area 210 for controlling a security environment (e.g., mode switching). In this case, the first driving area 200 may transmit a security environment switch request to monitor module 240 via security execution environment driver 252. The request may comprise information associated with a security level of the security environment, a request for an identification code, and an identification code input area that permits input of an identification code. When electronic device 101 displays the security level with one or more colors of one or more light emitting elements (e.g., LED) included in the electronic device 101, the first driving area 200 may transmit color code indicative of the security level received from the security execution environment driver 252. The first driving area 200 may transmit this color code to the monitor module 240 via a display driver 254.

The second driving area 210 may identify the information transmitted to the monitor module and may determine whether the information transmitted to the monitor module was changed in an unauthorized manner. When the electronic device 101 determines that the information included in the monitor module has valid authority, the second driving area 210 may display the color code via the light emitting element, and may identify the identification code which is input via the identification code input area provided by the first driving area 200. When it is determined that the input identification code has valid authority or is a wrong identification code, the second driving area 200 may display a corresponding color code via the light emitting element.

Hereinafter, an example of the present disclosure will be discussed with reference to FIG. 2C. Referring to FIG. 2C, the electronic device 101 may use at least one of one or more display devices included in the electronic device 101 to display a security status of the electronic device 101 (e.g., a security level). The display device 224 may be at least one of one or more light emitting elements such as LED included in the electronic device 101, a level meter, and some or all areas of the display device 224.

In the example of FIG. 2C, the electronic device 101 may display a security status indicative of a security level of the electronic device 101 with one or more designated colors corresponding to the security level via a light emitting element 280 included in the electronic device 101. The first driving area 200 may control operations corresponding to a first security level, a second security level, and a third security level of the electronic device 101, and may output a display indicative of the security level (e.g., a display via the light emitting element). The second driving area 210 may also control operations corresponding to the first security level, the second security level, the third security level, or a fourth security level of the electronic device 101, and may also output a display indicative of the above-described security levels.

While accessing the Internet via network communication, the first driving area 200 of the electronic device 101 may output a first display 281 or a second display 283 indicative of a security status of the Internet access (e.g., a first security level or a second security level in accordance with each page) via the light emitting element. When user login is required in a communication area designated via a network, the first driving area 200 of the electronic device 101 may display a login screen, and may output a third display 285 indicating a security status (e.g., a third security level) of the login screen via the light emitting element. When one or more functions are operated in the first security level, the electronic device 101 may authenticate the functions using the second driving area 210. The second driving area 210 of the electronic device 101 may identify whether there is an unauthorized change or a security breach and may output the third display 285 accordingly.

By way of example, when a user's payment is required in a communication area designated via a network, the first driving area 200 of the electronic device 101 may request the second driving area 210 to perform a security authentication procedure. The first driving area 200 may further request the second driving area 210 to output a fourth display 287 (e.g., the light emitting element) indicative of the security status (e.g., a fourth security level) corresponding to the security authentication procedure. The second driving area 210 of the electronic device 101 may authenticate the incoming request of the first driving area 200. The second driving area 210 may identify whether there is an unauthorized change in the response to the request for security authentication.

Here, the unauthorized change is not just attempting to login, the unauthorized change is about reliability of system, for example, whether the login page is cheated or not. In turn, second driving area 210 may determine whether to output a result of the security authentication on the fourth display 287. When the change is authorized, the electronic device 101 may output the fourth display 287 and may perform the security authentication procedure.

In one example, the electronic device 101 may use color to indicate the security status of the electronic device 101. Such a color may be displayed using a light emitting element and may be a variety of colors. Electronic device 101 may also indicate the security status using a level meter (291, 293, 295) as shown in FIG. 2C (b). The example level meter may be able to indicate 4 levels or stages of security. First driving area 200 may output displays indicative of the first security level, the second security level, and the third security level, and second driving area 210 may output displays indicative of all security levels or stages. The electronic device 101 may be controlled by the second driving area 210 when performing a function corresponding to the fourth security level or outputting the fourth display corresponding to the fourth security level.

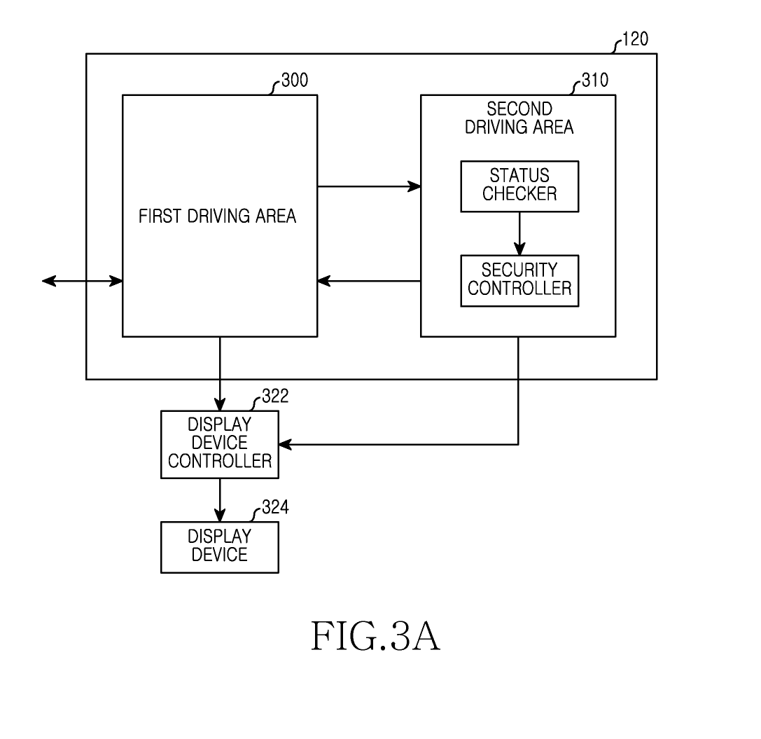

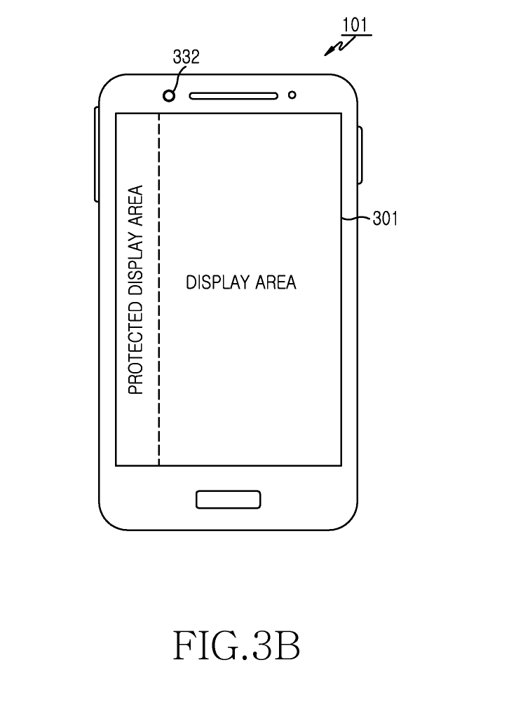

Referring now to FIGS. 3A, 3B and 3C, working examples of the techniques disclosed herein are shown.

Referring to FIG. 3A, The electronic device 101 may include a display device controller 322 for identifying a display indicative of a security status of the electronic device 101 under the control of a first driving area 300 and/or second driving area 310. Display device 324 may output the security status indication. When the first driving area 300 requests a security-related operation controlled by the second driving area 310 while the electronic device 101 is performing a function, the first driving area 300 may transmit display information to the display device controller 322 to output the display information indicative of a security level of the security-related operation. The second driving area 310 may authenticate the requested security-related operation and the display information which is received by the display device controller 322 from the first driving area 300. When the security-related operation and the display information are authenticated, the second driving area 310 may perform the security-related operation requested by the first driving area 300. When the display information controlled in the first driving area 300 is changed in an unauthorized manner, the second driving area 310 may change the display indicative of the security level of the security-related operation requested by the first driving area 300. When the second driving area 310 resets the display information via the display device controller 322 and outputs the new display information on the display device 324, the second driving area 310 may preempt the display information of the first driving area 300. When the display information controlled by the first driving area 300 is changed in an unauthorized manner or data changed in an unauthorized manner is identified in the process of requesting the security-related operation, the second driving area 310 may output an error code.

Referring to the example in FIG. 3B, the first driving area 300 or the second driving area 310 may include a display device 105 for outputting a security status of the electronic device 101. One or more light emitting elements 332 or display modules 150 which may output a variety of colors may serve as the display device 105 for displaying the security status of the electronic device 101.

Referring to FIG. 3B, the first driving area and the second driving area may output security status information (e.g., a screen display method indicative of a security level) of the electronic device 101 to a display device 301 via a display device controller 322 connected with the electronic device 101. When the electronic device 101 outputs screen display methods indicative of different security levels of electronic device 101 to the display device 301, the second driving area has priority to control the display device controller 322 over the first driving area, and a screen display method indicative of a security level determined by the second driving area may be output to the display device 301.

The display module 150 shown in FIG. 3B may be configured as a general display area which may be controlled by the first driving area and the second driving area, and may include a protected display area which is inaccessible by the first driving area (e.g., which is controlled by the second driving area). The electronic device 101 may display the security status information of the electronic device 101 on a designated area of the display module 150 under the control of the first driving area. The second driving area may authenticate the security status information of the electronic device 101 displayed under the control of the first driving area, and, when the security status information includes data changed in an unauthorized manner, the second driving area may output a notification indicative of the changed data on a protected display area of the display module 150.

Referring now to the example in FIG. 3C, the processor 120 of the electronic device 101 may be configured to go through a monitor module 340 when sharing all or some data between a first driving area 300 and a second driving area 310. The monitor module 340 may store data which is exchanged between the first driving area 300 and the second driving area 310 to process an operation which needs to be performed in a security environment in which enhanced security is maintained. When an identification code input requiring security is required during an operation in the first driving area 300, the electronic device 101 may switch to the second driving area 310 for controlling the security environment (e.g., mode switching). In this instance, the first driving area 300 may transmit, to the monitor module 340 via a security execution environment driver 352 within a kernel 350, a requesting to switch to the security environment, a security level of a corresponding security environment, an identification code, and an identification code input area for inputting the identification code. The first driving area 300 may identify a security status of the electronic device 101 based on information transmitted to the monitor module 340, and may configure a display method that the display device controller 372 displays on the display device 105 (e.g., 384 of FIG. 3C) in accordance with the determined security status information. The first driving area 300 may output the configured display method to the display device 384. The second driving area 310 may authenticate information acquired in the monitor module 340. The electronic device 101 authenticates the acquired information and may configure a display method that the display device controller 372 displays on the display device 384. When outputting the configured display method to the display device 384, the second driving area 310 may output the display method to a designated area (e.g., the protected display area of FIG. 3B) of the display module 150 which is inaccessible by the first driving area.

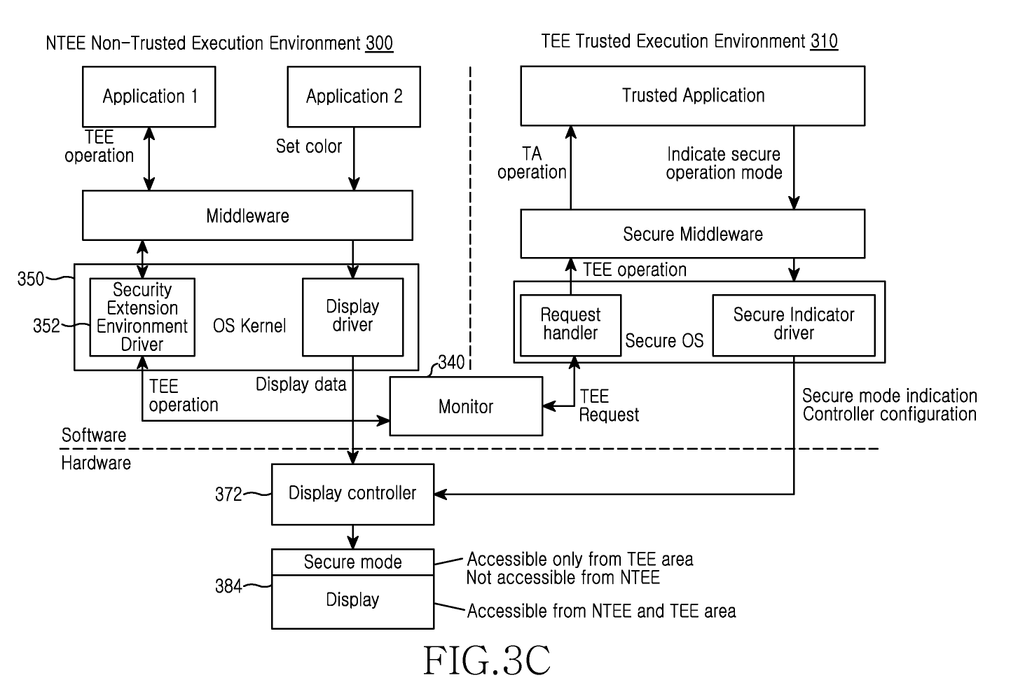

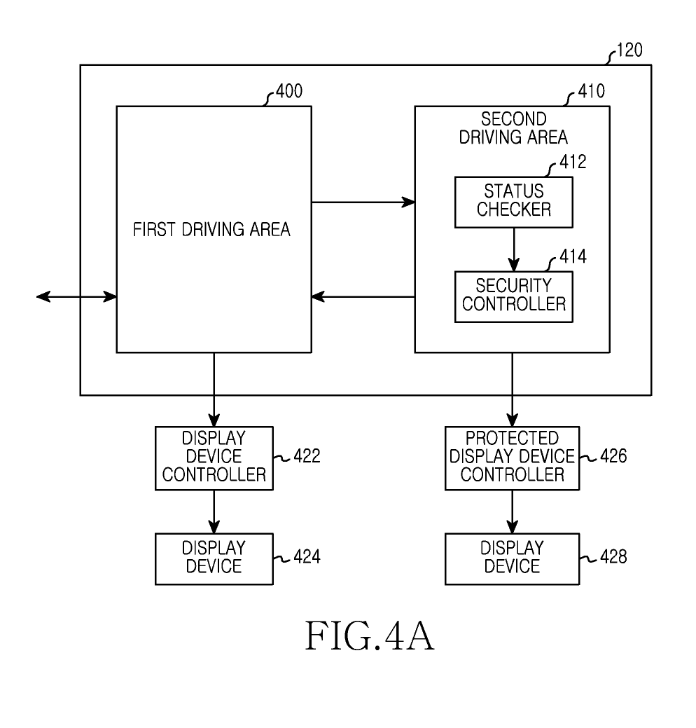

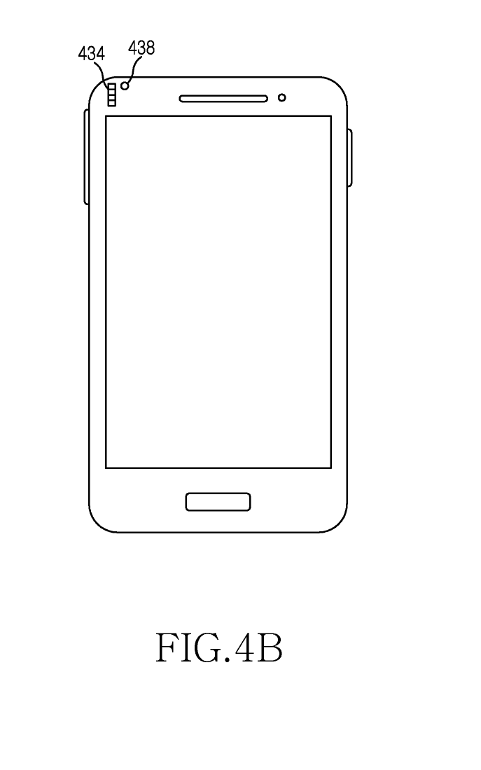

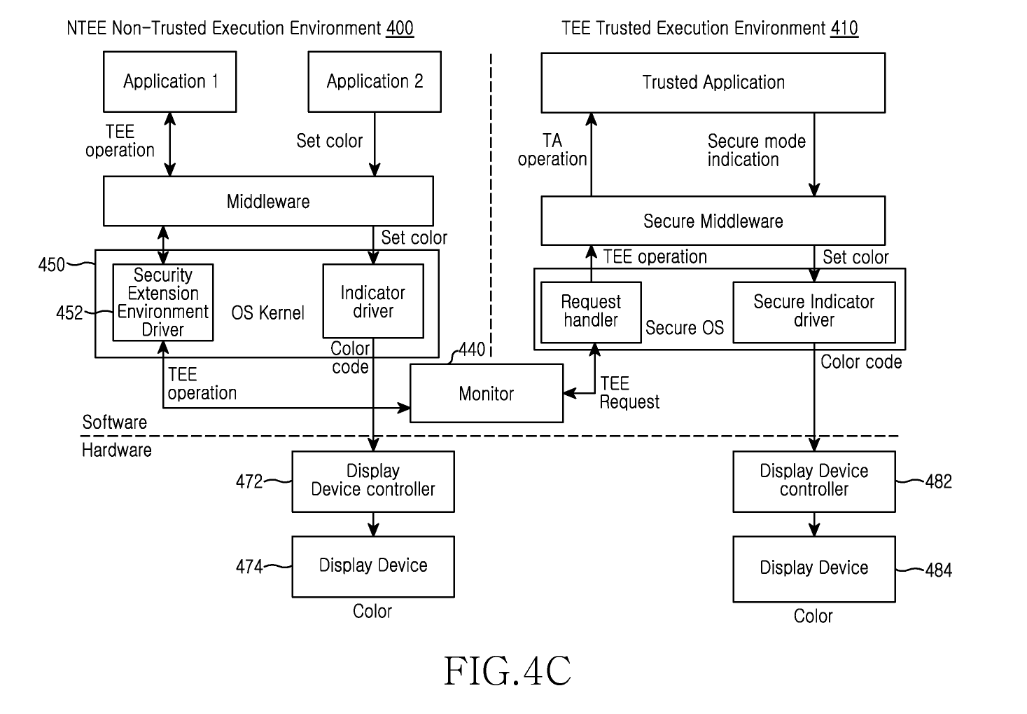

Referring now to FIGS. 4A, 4B and 4C working examples of the processor 120 are shown. The electronic device 101 may include a display device controller 422 for determining a display indicative of a security status of the electronic device 101 and a display device 424 for outputting the determined display, which are controlled by a first driving area 400, and may include a protected display device controller 426 for determining a display indicative of a security status of the electronic device 101, and a display device 428 (e.g., a protected display device controlled by the second driving area) for outputting the determined display, which are controlled by a second driving area 410. Referring now to the example of FIG. 4A, the first driving area 400 may request the second driving area to perform a security authentication procedure. In this case, the first driving area may identify a notification that indicates the start of the security authentication procedure or display a signal indicative of the execution of the authentication procedure via the display device controller 422, and may output the determined display signal to the display device 424.

The second driving area 410 may also identify a notification that indicates the start of the security authentication procedure in accordance with the request for the security authentication procedure received from the first driving area, or a display a signal indicative of the execution of the security authentication procedure via the protected display device controller 426. Second driving area 410 may output the signal on display device 428. When the display signal determined in the first driving area and output to the display device 424 is the same as the display signal output to the display device 428, the second driving area may perform the requested security authentication procedure. When the security level is changed while the security authentication procedure executes, the display signal output to the display device 428 may be changed. In this instance, the second driving area may identify a display signal indicative of the new security level via the protected display device controller 426, and output the display signal to the display device 428.

Referring now to the example of FIG. 4B, the electronic device 101 may include a display device 434 (e.g., 424 of FIG. 4A or 428 of FIG. 4A) which is controlled by the first driving area 400, and a display device 438 (e.g., 428 of FIG. 4A or 424 of FIG. 4A) which is controlled by the second driving area 410.

In one example, when the display device 434 controlled by the first driving area 400 is a level meter, the first driving area may output a display signal indicative of a security status of the electronic device 101 to the display device 434 with one or more levels. When the display device 438 controlled by the second driving area 410 is a light emitting element (e.g., one or more color representing LEDs), the second driving area may output the display signal indicative of the security status of the electronic device 101 to the display device 438 with one or more colors. The display device 438 controlled by the second driving area of the electronic device 101 may be a protected display device 438 which is inaccessible by the first driving area.

Referring now to the example in FIG. 4C, the processor 120 of the electronic device 101 may be configured to go through a monitor module 440 when sharing all or some of data between a first driving area 400 and a second driving area 410. The monitor module 440 may store data which is exchanged between the first driving area 400 and the second driving area 410 to process an operation which needs to be performed in a security environment in which security is enhanced. When an identification code input requiring security is detected by the first driving area 400, the electronic device 101 may switch to the second driving area 410 for controlling the security environment (e.g., mode switching). In this case, the first driving area 400 may transmit, to the monitor module 340 via a security execution environment driver 452 in kernel 450, a request to switch to the security environment, a security level of the environment, an identification code, and an identification code input area that permits the identification code to be input. The first driving area 400 may identify the security status of electronic device 101 based on the information transmitted to the monitor module 440, and may configure a display method that the display device controller 472 displays on the display device 105 (e.g., 474 of FIG. 4C) that is indicative of the security status. The first driving area 400 may output the configured display method to the display device 474. The second driving area 410 may authenticate the information acquired in the monitor module 440. The electronic device 101 may authenticate the acquired information and may configure a display method that the display device controller 482 displays on the display device 384. When outputting the configured display method to the display device 484, the second driving area 410 may output the display method to a protected display device 484 which is inaccessible by the first driving area.

Referring now to the example method of FIG. 5, the electronic device 101 may output security status information of the electronic device 101 via a display device connected with a second driving area to which security is applied, and the display device connected with the second driving area may be an output which is inaccessible by the first driving area and is under the control of the second driving area.

In operation 501, when the first driving area of the electronic device 101 performs a function requiring security authentication, the first driving area may transmit information associated with this function to the second driving area. Thus, control may be switched from the first driving area to the second driving area. The second driving area may control the enhanced security environment of the electronic device 101 and perform the security authentication procedure. Transmitting the information associated with the function to the second driving area may include an operation of the memory 130 in which the information is stored.

In operation 503, the second driving area of the electronic device 101 may authenticate the function as requested by the first driving area. By way of example, when the second driving area performs an electronic payment function requested by the first driving area, the second driving area may authenticate a security level of the electronic payment function that was provided by the first driving area. The second driving area may determine whether there is a change in data when the reliability is not determined in operating of the electronic payment function. When there is no change in the data when the reliability is not approved, the second driving area may output a display signal of the security level determined by the first driving area and may continue to perform the requested electronic payment function. When the security level of the electronic device 101 is changed and the second driving area performs the electronic payment function, the second driving area may detect a change in the security level of the electronic device 101. When the determined security level satisfies a predetermined condition of reliability, the second driving area completes the performance of the electronic payment function.

In operation 505, the second driving area may output the result of the reliability/unreliability of the security level authentication determined to the display device of the electronic device 101. When the security level determined by the first driving area satisfies the condition of the reliability, the second driving area may output the display signal corresponding to the security level determined by the first driving area to the display device, and, when the security level does not satisfy the condition of the reliability, the electronic device 101 may output a display signal corresponding to an error code to the display device or may output a display signal indicative of a security level determined by the second driving area. Note that the first driving area does not operate authentication, just call authentication operation or a program which operates authenticating. Authentication operates in the second driving area.

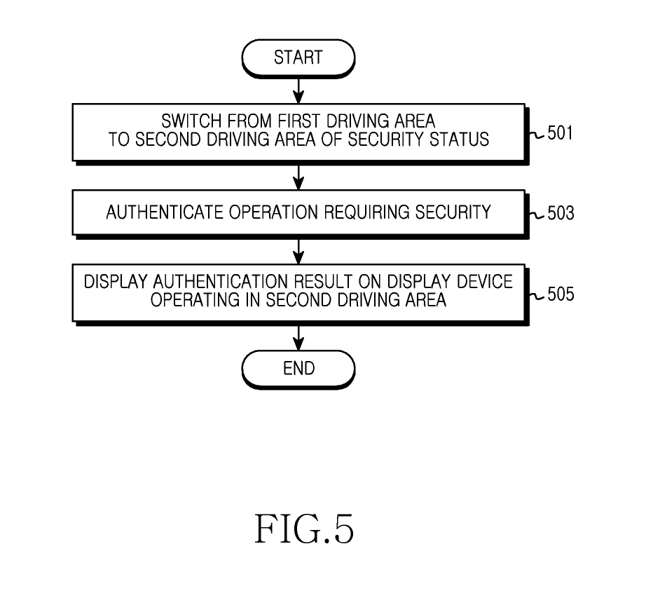

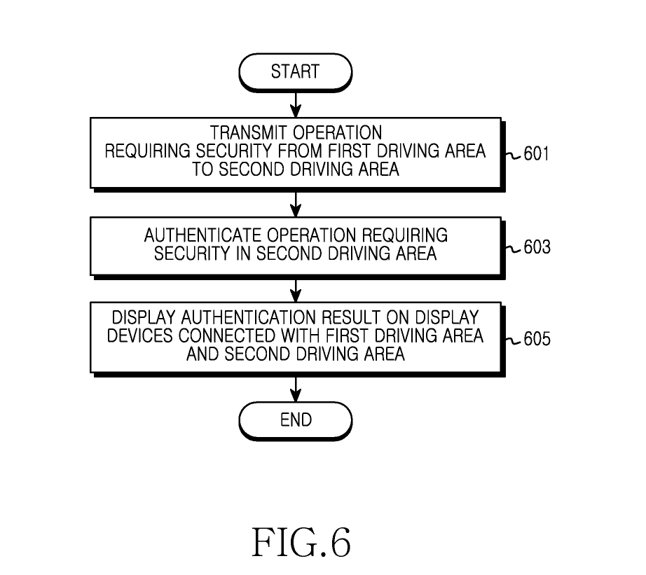

Referring now to the example method of FIG. 6, the electronic device 101 may output security status information of the electronic device 101 via display devices connected with a first driving area and a second driving area. The display device associated with the second driving area may be configured to be inaccessible by the first driving area.

In operation 601, the first driving area may transmit an operation to the second driving area, when operation is a sensitive operation requiring security authentication. Thus, the first driving area may request the second driving area to perform a security authentication procedure, and may determine a security status of the electronic device 101. The first driving area may output a display signal indicative of the security status (e.g., a security level) to the display device connected with the first driving area.

In operation 603, the second driving area may authenticate the display signal output by the first driving area to ensure that the display signal is indeed indicative of the security status, and may output a display signal indicative of the authentication result on the display device connected with the second driving area. When the second driving area determines that the display signal output by the first driving is reliable, the second driving area may perform the security authentication procedure requested by the first driving area. When the security level of the electronic device 101 is changed while the second driving area performs the security authentication procedure, the second driving area may authenticate the security level again, and may transmit a display signal indicative of the security level to the first driving area.

In operation 605, the first driving area of the electronic device 101 may output the display signal received from the second driving area to the display device connected with the first driving area, and the second driving area may output the determined display signal to the display device connected with the second driving area.

When outputting the security status of the electronic device 101, the first driving area may output the display signal determined by the first driving area via the display device controlled by the first driving area, and the second driving area may output the display signal determined by the second driving area via the display device controlled by the second driving area. The display device connected with the second driving area may be inaccessible by the first driving area and may be controlled by the second driving area. Accordingly, when the display signal output to the display device connected with the first driving area is different from the display signal output to the display device connected with the second driving area in the middle of the security authorization procedure of the electronic device 101, it may be determined that all or some of the data operating in the security authorization procedure has changed in an unauthorized manner. In this instance, the second driving area may end the security authorization procedure with an error code.

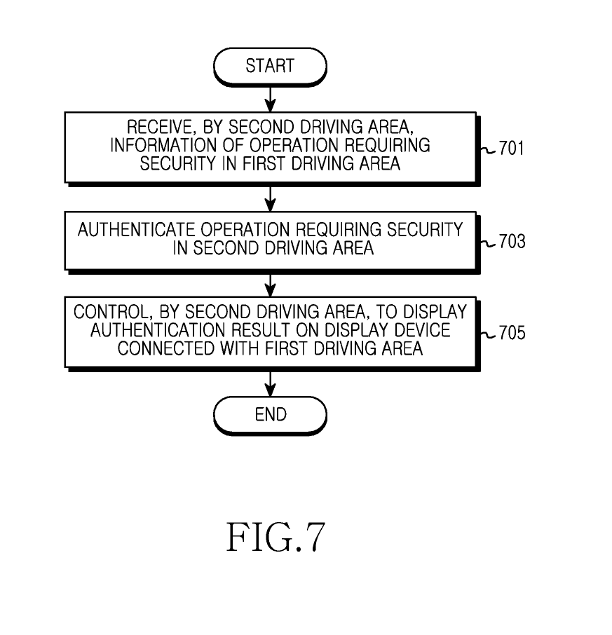

Referring now to the example method of FIG. 7, the electronic device 101 may control to output security status information via a display device connected with a first driving area, and a second driving area may authenticate the security status information that the first driving area controls to output and may control a display signal output by the first driving area.

In operation 701, the first driving area may request the second driving area to perform an operation corresponding to a function requiring a designated security environment of the electronic device 101, and may determine a security status of the electronic device 101 which performs a security authentication procedure. The first driving area may control to output a display signal corresponding to the determined security status (e.g., security level) to the display device connected with the first driving area.

In operation 703, the second driving area may authenticate the operation and, when it is determined that data is changed in an unauthorized manner, the second driving area may prevent the display of a signal indicative of a security status output by the first driving area. The second driving area may output an error code instead of the display signal output by the first driving area, or may output a display signal indicative of a security level determined by the second driving area. When it is determined that the display signal output by the first driving area satisfies a condition of the reliability, the second driving area may perform the security authentication procedure requested by the first driving area. When the security level of the electronic device 101 is changed while the second driving area performs the security authentication procedure, the second driving area may repeat the authentication and may transmit a display signal corresponding to the determined security level to the first driving area.

In operation 705, the second driving area of the electronic device 101 may output the authentication result. Note that, for example, the display device is connected to the first driving area, and the first driving area can control the display device. But authentication result is displayed by the second driving area's control, thus the first driving area cannot intervene to displaying the authentication result. When outputting the security status of the electronic device 101, the first driving area may output the display signal determined by the first driving area via the display device controlled by the first driving area, and the second driving area may control the display signal output via the display device in accordance with whether the display signal to be output to the display device has been determined in an authorized manner. The display signal controlled by the second driving area may be inaccessible by the first driving area.

In one example, a method may comprise displaying, using a first driving area of at least one processor, a security authentication screen; switching from using the first driving area of the at least one processor to a second driving area of the at least one processor; performing a security authentication procedure with the second driving area; and outputting a result of the security authentication procedure generated by the second driving area. In a further example, the first driving area and the second driving area may be logically or physically separated in one processor or physically and logically separated across a plurality of processors.

In another example, the second driving area may preempt the first driving area, when the second driving area is in use. In another aspect, the first driving area may be a general execution environment and the second driving area may be a security execution environment.

In a further example, the security authentication may comprise identification of an authorized user based on one or more of a password input, a certificate verification, a pattern input, a user information identification, an identification code input, an iris recognition, a fingerprint recognition, a brainwave recognition, a pulse wave recognition, and a voice recognition.

In yet another aspect, outputting the result may include outputting the result on one or more display devices connected to the electronic device. Outputting the result may further include using at least one of a light emitting element, a level meter, an entirety or part of a display device, and a vibration pattern of a motor. In yet another aspect, the results may be output through a second display device controlled by the second driving area that is separate from a first display device controlled by the first driving area. In another example, the second driving area may display the result on a display device associated with the first driving area. In another example, the result generated by the second driving area may be output, when the result of the security authentication procedure generated by the second driving area is different than that which is generated by the first driving area.

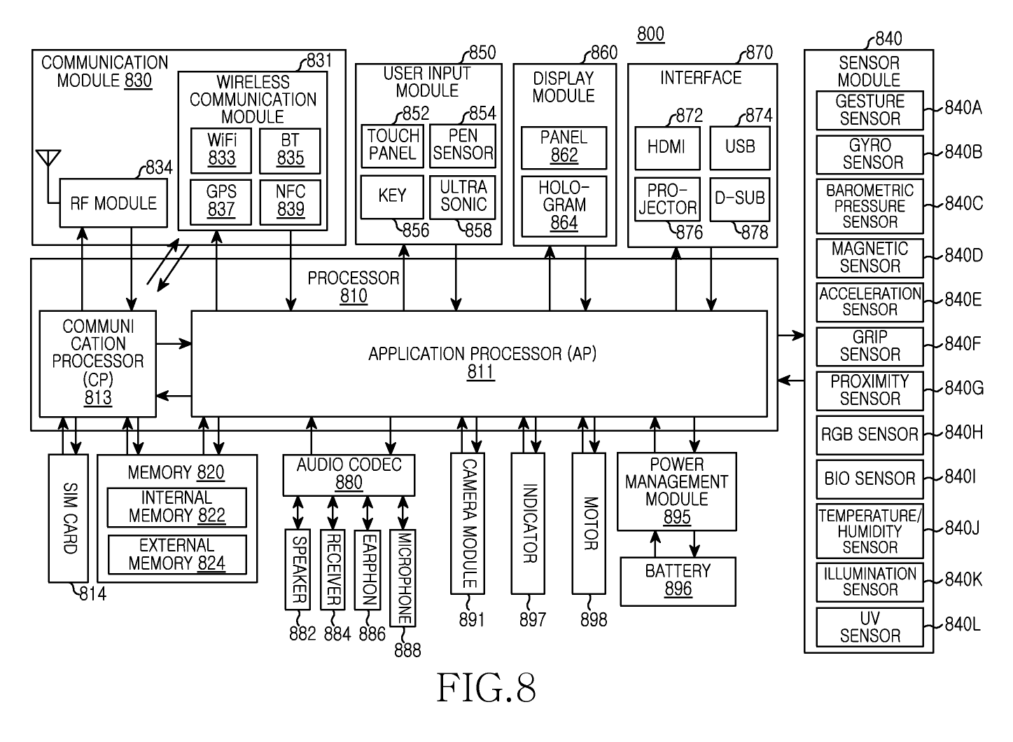

Referring now to FIG. 8, a block diagram of example hardware 800 is shown. Hardware 800 may constitute an entirety or part of the electronic device 101 illustrated in FIG. 1. Referring to FIG. 8, the hardware 800 may include one or more processors 810, a Subscriber Identification Module (SIM) card 814, a memory 820, a communication module 830, a sensor module 840, a user input module 850, a display module 860, an interface 870, an audio CODEC 880, a camera module 891, a power management module 895, a battery 896, an indicator 897, or a motor 898.

The processor 810 (e.g., the processor 120) may include one or more Application Processors (APs) 811 or one or more Communication Processors (CPs) 813. The processor 810 may be the processor 120 shown in FIG. 1, for example. Although the AP 811 and the CP 813 are included in the processor 810 in FIG. 8, the AP 811 and the CP 813 may be included in different IC packages. The AP 811 and the CP 813 may be included in a single IC package.

The AP 811 may control a plurality of hardware or software elements connected to the AP 811 by driving an operating system or an application, and may process and operate various data including multimedia data. The AP 811 may be implemented by using a SoC, for example. The processor 810 may further include a Graphic Processing Unit (GPU) (not shown).

The CP 813 manages a data link in communication between an electronic device (e.g., the electronic device 101) including the hardware 800 and other electronic device connected via a network, and converts a communication protocol. The CP 813 may be implemented by using a SoC, for example. The CP 813 may perform at least some of multimedia control functions. For example, the CP 813 may identify and authenticate a terminal in a communication network by using a SIM (e.g., the SIM card 814). In addition, the CP 813 may provide services such as a voice call, a video call, a text message, or packet data to the user.

In addition, the CP 813 may control data exchange of the communication module 830. Although the elements such as the CP 813, the power management module 895, or the memory 820 are illustrated as separate elements from the AP 811 in FIG. 8, the AP 811 may be implemented to include at least some of the above-described elements (e.g., the CP 813).

In one example, the AP 811 or the CP 813 may load an instruction or data which is received from a non-volatile memory connected to the AP 811 or the CP 813 or at least one of the other elements into a volatile memory, and may process the instruction or data. In addition, the AP 811 or the CP 813 may store data which is received from at least one of the other elements or generated by at least one of the other elements in the non-volatile memory.

The SIM card 814 is a card in which a subscriber identification module is implemented, and may be inserted into a slot formed on a specific location of the electronic device. The SIM card 814 may include its unique identification information (for example, an Integrated Circuit Card Identifier (ICCID)) or subscriber information (for example, International Mobile Subscriber Identity (IMSI)).

The memory 820 may include an internal memory 822 or an external memory 824. For example, the memory 820 may be the memory 130 shown in FIG. 1. For example, the internal memory 822 may include at least one of a volatile memory (for example, a Dynamic Random Access Memory (DRAM), a Static Random Access Memory (SRAM), a Synchronous DRAM (SDRAM), etc.) or a non-volatile memory (for example, an One-Time Programmable Read Only Memory (OTPROM), a Programmable Read Only Memory (PROM), an Erasable Programmable Read Only Memory (EPROM), an Electrically Erasable Programmable Read Only Memory (EEPROM), a mask ROM, a flash ROM, a NAND flash memory, a NOR flash memory, etc.). The internal memory 822 may be in the form of a Solid State Driver (SSD). The external memory 824 may further include a flash driver, for example, Compact Flash (CF), Secure Digital (SD), Micro-SD, Mini-SD, xD, memory stick, etc.

The communication module 830 may include a wireless communication module 831 or a Radio Frequency (RF) module 834. For example, the communication module 830 may be the communication interface 160 shown in FIG. 1. For example, the wireless communication module 831 may include WiFi 833, BT 835, GPS 837, or NFC 839. For example, the wireless communication module 831 may provide a wireless communication function using radio frequency. Additionally or alternatively, the wireless communication module 831 may include a network interface (for example, a LAN card) or a modem for connecting the hardware 800 to a network (for example, Internet, LAN, WAN, a telecommunication network, a cellular network, a satellite network, POTS, etc.)

The RF module 834 may responsible for exchange of data, for example, exchange of RF signals or signals of a called electronic device. Although not shown, the RF module 834 may include a transceiver, a Pluggable Authentication Module (PAM), a frequency filter, or a Low Noise Amplifier (LNA), for example. In addition, the RF module 834 may further exchange electromagnetic waves in a free space in wireless communication, for example, a conductor or conducting wire.

For example, the sensor module 840 may include at least one of a gesture sensor 840A, a gyro sensor 840B, a barometric pressure sensor 840C, a magnetic sensor 840D, an acceleration sensor 840E, a grip sensor 840F, a proximity sensor 840G, a Red, Green, Blue (RGB) sensor 840H, a biosensor 840I, a temperature/humidity sensor 840J, a luminance sensor 840K, or a Ultraviolet (UV) sensor 840L. The sensor module 840 may measure a physical quantity or detect an operation state of the electronic device, and convert measured or detected information into electric signals. Additionally or alternatively, the sensor module 840 may include an odor sensor (not shown), an electromyography (EMG) sensor (not shown), an electroencephalogram (EEG) sensor (not shown), an electrocardiogram (ECG) sensor (not shown), a fingerprint sensor, etc. The sensor module 840 may further include a control circuit to control at least one sensor included therein.

The user input module 850 may include a touch panel 852, a (digital) pen sensor 854, a key 856, or an ultrasonic input device 858. For example, the user input module 850 may be the input and output interface 140 shown in FIG. 1. For example, the touch panel 852 may recognize a touch input in at least one method of capacitive, resistive, infrared, and ultrasonic methods. In addition, the touch panel 852 may further include a controller (not shown). In the case of a capacitive method, the touch panel 852 may recognize not only physical contact but also approach. The touch panel 852 may further include a tactile layer. In this case, the touch panel 852 may provide a tactile response to the user.

The (digital) pen sensor 854 may be implemented in the same or similar method as or to the method of receiving a user's touch input or by using a separate recognition sheet. The key 856 may use a keypad or a touch key. The ultrasonic input device 858 allows a terminal to detect sound waves through a microphone (for example, the microphone 888) through a pen generating ultrasonic signals, and is capable of wireless recognition. In another example, the hardware 800 may receive a user input from an external device connected thereto (for example, a network, a computer, or a server) by using the communication module 830.

The display module 860 may include a panel 862 or a hologram 864. For example, the display module 860 may be the display device 105 shown in FIG. 1. For example, the panel 862 may be a Liquid Crystal Display (LCD) or an Active Matrix Organic Light Emitting Diode (AM-OLED). For example, the panel 862 may be implemented flexibly, transparently, or to be wearable. The panel 862 may be configured as a single module along with the touch panel 852. The hologram 864 may show a stereoscopic image in the air using interference of light. Display module 860 may further include a control circuit to control the panel 862 or the hologram 864.

The interface 870 may include a High Definition Multimedia Interface (HDMI) 872, a Universal Serial Bus (USB) 874, a projector 876, or D-sub 878. Additionally or alternatively, the interface 870 may include a SD/Multimedia Card (MMC) (not shown) or Infrared Data Association (IrDA) (not shown).

The audio CODEC 880 may convert a sound and electric signal bidirectionally. The audio CODEC 880 may convert sound information which is input or output through a speaker 882, a receiver 884, an earphone 886, or a microphone 888.

The camera module 891 is a device for photographing an image and a moving image, and may include one or more image sensors (for example, a front surface sensor or a rear surface lens), a lens, an Image Signal Processor (ISP) (not shown), or a flash (memory).

The power management module 895 may manage power of the hardware 800. Although not shown, the power management module 895 may include a Power Management IC (PMIC), a charging IC, or a battery gage.

For example, the PMIC may be mounted in an integrated circuit or a SoC semiconductor. The charging method may be divided into a wired charging method and a wireless charging method. The charging IC may charge a battery and may prevent inflow of overvoltage or over current from a charger. The charging IC may include a charging IC for at least one of the wired charging method and the wireless charging method. The wireless charging method may include a magnetic resonance method, a magnetic induction method, or an electromagnetic wave method, and an additional circuit for charging wirelessly, for example, a circuit such as a coil loop, a resonant circuit, a rectifier, etc. may be added.

For example, the battery gage may measure a remaining battery life of the battery 896, a voltage, a current, or temperature during charging. The battery 896 stores electricity and supplies power. The battery 896 may include a rechargeable battery.

The indicator 897 may display a specific state of the hardware 800 or a part of it (for example, the AP 811), for example, a booting state, a message state, or a charging state. The motor 898 may convert an electric signal into a mechanical vibration. The AP 811 or the MCU (not shown) may control the sensor module 840.

Although not shown, the hardware 800 may include a processing device (for example, a GPU) for supporting a mobile TV. The processing device for supporting the mobile TV may process media data in accordance with standards such as Digital Multimedia Broadcasting (DMB), Digital Video Broadcasting (DVB), or media flow. Each of the above-described elements of the hardware in accordance with the present disclosure may be comprised of one or more parts, and the names of the elements may vary in accordance with a kind of the electronic device. The hardware in accordance with the present disclosure may include at least one of the above-described elements, and some of the elements may be omitted or an additional element may be further included. In addition, some of the elements of the hardware in accordance with the present disclosure may be combined into a single object, and may perform the same functions as those of the elements before being combined.

In a further aspect of the present disclosure, an electronic device may comprise at least one processor having a first driving area and a second driving area. The at least one processor may be configured to: display, using the first driving area, a security authentication screen; switch from using the first driving area to using the second driving area; perform a security authentication procedure with the second driving area; and output a result of the security authentication procedure generated by the second driving area. The first driving area and the second driving may be logically or physically separated in one processor or physically and logically separated across a plurality of processors. The second driving area may preempt the first driving area, when the second driving area is in use. The first driving area may be a general execution environment and the second driving area may be a security execution environment.

In a further example, the security authentication comprises identification of an authorized user of the security authentication based on one or more of a password input, a certificate verification, a pattern input, a user information identification, an identification code input, an iris recognition, a fingerprint recognition, a brainwave recognition, a pulse wave recognition, and a voice recognition.

In another example, the at least one processor may output the result on one or more display devices connected to the electronic device. Alternatively, the at least one processor may output the result using at least one of a light emitting element, a level meter, an entirety or part of a display device, and a vibration pattern of a motor.

In another aspect, the at least one processor may be further configured to output the result on a second display device controlled by the second driving area that is separate from a first display device controlled by the first driving area. Alternatively, the at least one processor may output the result, using the second driving area, on a display device associated with the first driving area.

In yet another example, the at least one processor is further configured to output the result generated by the second driving area, when the result of the security authentication procedure generated by the second driving area is different than that which is generated by the first driving area.

Advantageously, the electronic device disclosed herein outputs the security status of the electronic device in a security area of the processor which is logically or physically separated from a general area of the processor. In turn, the security status displayed by the electronic device may be reliable.

The above-described embodiments of the present disclosure can be implemented in hardware, firmware or via the execution of software or computer code that can be stored in a non-transitory computer readable medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

In addition, an artisan understands and appreciates that a “processor” or “microprocessor” constitute hardware in the claimed invention. Under the broadest reasonable interpretation, the appended claims constitute statutory subject matter in compliance with 35 U.S.C. §101. The functions and process steps herein may be performed automatically or wholly or partially in response to user command. An activity (including a step) performed automatically is performed in response to executable instruction or device operation without user direct initiation of the activity.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

What is claimed is:

1. A method in an electronic device, the method comprising:
displaying, using a first driving area of at least one processor, a security authentication screen;
switching from using the first driving area of the at least one processor to a second driving area of the at least one processor;
performing a security authentication procedure with the second driving area; and
outputting a result of the security authentication procedure generated by the second driving area.

2. The method of claim 1, wherein the first driving area and the second driving area are logically or physically separated in one processor or physically and logically separated across a plurality of processors.

3. The method of claim 2, wherein the second driving area preempts the first driving area, when the second driving area is in use.

4. The method of claim 1, wherein the first driving area is a general execution environment and the second driving area is a security execution environment.

5. The method of claim 1, wherein the security authentication comprises identification of an authorized user based on one or more of a password input, a certificate verification, a pattern input, a user information identification, an identification code input, an iris recognition, a fingerprint recognition, a brainwave recognition, a pulse wave recognition, and a voice recognition.

6. The method of claim 1, wherein outputting the result comprises outputting the result on one or more display devices connected to the electronic device.

7. The method of claim 1, wherein outputting the result comprises outputting the result using at least one of a light emitting element, a level meter, an entirety or part of a display device, and a vibration pattern of a motor.

8. The method of claim 1, wherein outputting the result comprises outputting the result through a second display device controlled by the second driving area that is separate from a first display device controlled by the first driving area.

9. The method of claim 1, wherein outputting the result comprises outputting, using the second driving area, the result on a display device associated with the first driving area.

10. The method of claim 1, wherein outputting the result generated by the second driving area further comprises, outputting the result generated by the second driving area, when the result of the security authentication procedure generated by the second driving area is different than that which is generated by the first driving area.

11. An electronic device comprising:
at least one processor having a first driving area and a second driving area, the at least one processor being configured to:
display, using the first driving area, a security authentication screen;
switch from using the first driving area to using the second driving area;
perform a security authentication procedure with the second driving area; and
output a result of the security authentication procedure generated by the second driving area.

12. The electronic device of claim 11, wherein the first driving area and the second driving area are logically or physically separated in one processor or physically and logically separated across a plurality of processors.

13. The electronic device of claim 12, wherein the second driving area preempts the first driving area, when the second driving area is in use.

14. The electronic device of claim 11, wherein the first driving area is a general execution environment and the second driving area is a security execution environment.

15. The electronic device of claim 11, wherein the security authentication comprises identification of an authorized user of the security authentication based on one or more of a password input, a certificate verification, a pattern input, a user information identification, an identification code input, an iris recognition, a fingerprint recognition, a brainwave recognition, a pulse wave recognition, and a voice recognition.

16. The electronic device of claim 11, wherein, to output the result, the at least one processor is further configured to output the result on one or more display devices connected to the electronic device.

17. The electronic device of claim 11 wherein, to output the result, the at least one processor is further configured to output the result using at least one of a light emitting element, a level meter, an entirety or part of a display device, and a vibration pattern of a motor.

18. The electronic device of claim 11, wherein, to output the result, the at least one processor is further configured to output the result on a second display device controlled by the second driving area that is separate from a first display device controlled by the first driving area.

19. The electronic device of claim 11, wherein, to output the result, the at least one processor is further configured to output the result, using the second driving area, on a display device associated with the first driving area.

20. The electronic device of claim 11, wherein, to output the result, the at least one processor is further configured to output the result generated by the second driving area, when the result of the security authentication procedure generated by the second driving area is different than that which is generated by the first driving area.
